(19) United States
(12) Patent Application Publication
(10) Pub. No.: US 2025/0085243 A1
(43) Pub. Date: Mar. 13, 2025

(54) Method for Determining Phase Transition Temperature of Molten Salts

(71) Applicant: KOREA ATOMIC ENERGY RESEARCH INSTITUTE, Daejeon (KR)

(72) Inventors: Jong Yun KIM, Daejeon (KR); Tae Hyeong KIM, Daejeon (KR); Hwa Kyeung JEONG, Daejeon (KR); Sang Ho LIM, Daejeon (KR); Han Lim CHA, Daejeon (KR); Chan Yong JEONG, Daejeon (KR)

(21) Appl. No.: 18/826,351

(22) Filed: Sep. 6, 2024

(30) Foreign Application Priority Data
Sep. 8, 2023 (KR) 10-2023-0119841
Mar. 21, 2024 (KR) 10-2024-0039332

(51) Int. Cl. G01N 25/04

(52) U.S. Cl. CPC G01N 25/04

(57) ABSTRACT

According to the present disclosure, provided is a method for determining phase transition temperature using electrical conductivity. More specifically, according to the present disclosure, there is provided a method for determining phase transition temperature using electrical conductivity, including preparing a graph of the change in electrical conductivity of molten salts according to temperature, and performing at least one mathematical analysis of (i) performing a first-order differential on the graph, (ii) performing a second-order differential on the graph; and (iii) determining the number (n) of data and resolution (AT) based on the graph to derive Tₙ by Equation (1) below and performing linear regression analysis on a linear section to detect an outlier based on a distance from the linear regression equation,

$${T}_{n} = {T}_{max} - Δ T \times n \qquad Equation ( 1 )$$

where n denotes the number of data, and ΔT denotes an interval of measurement temperature and means resolution.

### CROSS-REFERENCE TO RELATED APPLICATION(S)

This application claims benefit of priorities to Korean Patent Application No. 10-2023-0119841 filed on Sep. 8, 2023 and Korean Patent Application No. 10-2024-0039332 filed on Mar. 21, 2024 in the Korean Intellectual Property Office, the disclosure of which is incorporated herein by reference in its entirety.

### BACKGROUND

### 1. Field

The present disclosure relates to relates to a method for determining phase transition temperature using electrical conductivity, and to a method capable of quickly and accurately determining phase transition temperature of a solid solution without using expensive purpose-built equipment.

### 2. Description of Related Art

Materials have a phase changing at a unique temperature. A temperature at which liquefied materials are solidified is known as a solidification temperature, and a temperature at which solid materials are melted is known as a melting temperature. A temperature at which the liquefied materials begin to solidify is known as a liquidus temperature, and temperature at which solid materials begin to melt is known as a solidus temperature.

When materials are pure without impurities, the temperature does not change during the phase change, so four phase change temperatures are the same. As long as a solid changes into a liquid and a liquid changes into a solid, the same temperature is maintained without any temperature change. However, all materials include impurities, which may cause differences in the four phase change temperature values. However, since the starting point remains unchanged even if the temperature changes, the liquidus temperature is a value that does not change. Accordingly, international temperature standards use the liquidus temperature of a specific material as the most ideal reference point.

Meanwhile, a molten salt reactor (MSR) uses liquid fuel in the form of a molten salt mixture and is attracting attention due to inherent safety characteristics thereof. The molten salt mixture should remain liquid within the desired temperature range and should have a relatively low melting point to implement efficient heat transfer and fluid dynamics within the reactor. Since the selection of the molten salt mixture with an appropriate melting point affects the safety, efficiency, and overall performance of the reactor, understanding the phase transition behavior of various mixtures of molten salts may be essential for the development of molten salt reactor design.

In order to evaluate the safety and material corrosiveness in fuel salts of a molten salt reactor, it is essential to derive a phase equilibrium diagram of the fuel salt according to compositions, and the phase transition temperature value experimentally determined in high-temperature molten salts may be very important for use as reference data for a fuel salt phase equilibrium diagram based on computational thermodynamics. In this regard, a method for measuring differential scanning calorimetry (DSC), a representative method for experimentally determining phase transition temperature has the problem that expensive special reactor cells are required to be used and large equipment in a small glove box should be installed in order to analyze molten salts which are very sensitive to moisture and oxygen in the atmosphere.

Meanwhile, Korean Patent No. 10-1412594 B1 discloses a method for measuring electrical conductivity of a solution. Therefore, it is expected that the Korean registered patent No. 10-1412594 B1 may be widely applied in related fields when it is possible to determine phase transition temperature using electrical conductivity that is suitable for use in actual process sites.

### SUMMARY

An aspect of the present disclosure may provide a method for determining electrical conductivity and determining phase transition temperature based on the determined electrical conductivity.

According to an aspect of the present disclosure, a method for determining phase transition temperature using electrical conductivity may include preparing a graph of change in electrical conductivity of molten salts according to temperature; and
performing at least one mathematical analysis of (i) performing first-order differential on the graph, (ii) performing second-order differential on the graph; and (iii) determining the number n of data and resolution ΔT based on the graph to derive Tₙ by Equation (1) below and performing linear regression analysis on a linear section to detect an outlier based on a distance from the linear regression equation,

$${T}_{n} = {T}_{max} - Δ T \times n \qquad Equation ( 1 )$$

where n denotes the number of data, and ΔT denotes an interval of measurement temperature and means resolution.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a diagram illustrating a schematic algorithm flowchart for determining phase transition temperature using electrical conductivity data;

FIG. 2 is a diagram illustrating definitions of items described in the algorithm flowchart of FIG. 1;

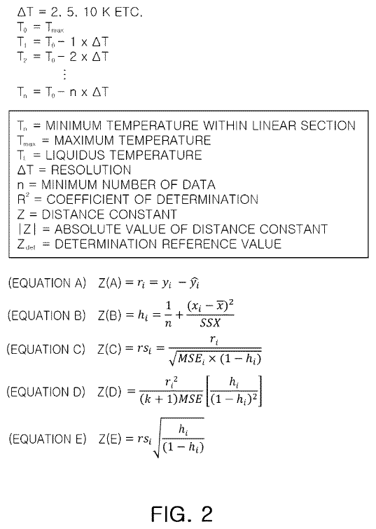

FIG. 3 is a diagram illustrating first-order differential (FIG. 3A) and second-order differential result graphs for measuring an electrical conductivity-temperature curve and phase transition temperature determined in (0.56LiCl-0. 44KCl)—NdCl₃ (30 wt %) molten salts (FIG. 3B); and

FIG. 4 is a diagram illustrating first-order differential (FIG. 4A) and second-order differential result graphs for measuring an electrical conductivity-temperature curve and phase transition temperature determined in (0.56LiCl-0.44KCl)—NdCl₃ (15 wt %) molten salts (FIG. 4B).

### DETAILED DESCRIPTION

Hereinafter, exemplary embodiments in the present disclosure will be described with reference to the accompanying drawings. However, exemplary embodiments in the present disclosure may be modified in several other forms, and the scope of the present disclosure is not limited to exemplary embodiments to be described below.

A phase transition behavior of the molten salt mixture is one of basic characteristics that should be most essential to understand in determining an operating temperature affecting the safety, efficiency, and overall performance of the molten salt reactor. According to the present disclosure, a new method for determining phase transition temperature using electrical conductivity data is provided.

In the method for determining phase transition temperature using electrical conductivity of the present disclosure, any material whose electrical conductivity is measured may be used without particular limitations, and may be a solid solution or molten salts having electrical conductivity, etc., and examples of the molten salts may include one or more selected from the group consisting of LiPF₆, LiF, KF, NaF, RbF, CsF, CaF₂, MgF₂, SrF₂, BaF₂, ALF₃, UF₃, UF₄, PuF₃, ThF₃, ZrF₄, NdF₃, CeF₃, LaF₃, LiCl, KCl, NaCl, Rbcl, CsCl, CaCl₂, MgCl₂, SrCl₂, BaCl₂, AlCl₃, UCl₃, UCI₄, PuCl₃, ThCl₃, ZrCl₄, NdCl₃, CeCl₃, LaCl₃, LiBr, KCBr, NaBr, RbBr, CsBr, CaBr₂, MgBr₂, SrBr₂, BaBr₂, UBr₃, AlBr₃, UBI₄, PuBI ₃, ThBr₃, ZrBr₄, NdBr₃, CeBr₃, LaBr ₃, LiI, KI, NaI, RbI, CsI, CaI₂, MgI₂, SrI₂, BaI₂, AlI₃, UI₃, UI₄, PuI₃, ThI₃, ZrI₄, NdI₃, CeI₃, LaIs, LiI, KI, NaI, LiNO₃, KNO₃, NaNO₃, RbNO₃ and CsNO₃, and preferably, may include one or more selected from the group consisting of LiCl—KCl, NaCl—KCl, NaCl—MgCl₂, LiCl—NaCl—CaCl₂—BaC₁₂, NaCl—KCl—BaCl₂, CsI, UCl₃, UCl₄, NdCl₃, CeCl₃, and LaCl₃.

In more detail, the method for determining phase transition temperature using electrical conductivity of the present disclosure includes preparing a graph of the change in electrical conductivity of molten salts according to a temperature change; and performing at least one mathematical analysis.

The performing of the mathematical analysis that may be applied to the present disclosure includes (i) performing first-order differential on the graph of the change in the electrical conductivity of the molten salts, (ii) performing second-order differential on the graph of the change in the electrical conductivity of the molten salts, and (iii) determining the number (n) of data and resolution (ΔT) based on the graph of the change in the electrical conductivity of the molten salts to derive Tₙ by Equation (1) below and performing linear regression analysis on a linear section to detect an outlier based on a distance from the linear regression equation.

$${T}_{n} = {T}_{max} - Δ T \times n \qquad Equation ( 1 )$$

(In equation (1) above, n denotes the amount of data, and ΔT denotes an interval of measurement temperature and means resolution.)

As a result of performing the mathematical analysis, in case of (i), a point where a value is highest when processing the first-order differential, in case of (ii), an inflection point where the value becomes 0 when processing the second-order differential, and in case of (iii), temperature corresponding to the outlier may be determined as the phase transition temperature.

The phase transition temperature to be measured in the present disclosure is not particularly limited as long as it is the temperature at which the phase of the material changes, but may be, for example, liquidus temperature T_{L}.

Meanwhile, when the difference between the liquidus temperature T_{L} and the solidus temperature T_{S} is 25° C. or lower, that is, the closer the gap is, the more difficult it may be to distinguish between the liquidus and solidus temperatures. In this case, when (iii) the performing of the mathematical analysis is included, relatively a accurate liquidus temperature T_{L} may be determined.

According to the present disclosure, the preparing of the graph of the change in the electrical conductivity of the molten salts according to the temperature change is first performed. In this case, the device or method for determining electrical conductivity is not limited and any known device or method for determining electrical conductivity may be used.

Meanwhile, when preparing the graph of the change in electrical conductivity of the molten salts according to the temperature change, the temperature change may be both the increase and decrease in temperature. For example, when measuring the electrical conductivity while lowering the temperature, the maximum temperature Tₘ higher than or equal to the melting point of the molten salts may be selected and the measurement may begin at the maximum temperature. In this case, the maximum temperature is not particularly limited, and may be, for example, a maximum temperature at which a high-temperature furnace may withstand, but considering process economic aspects, the temperature may be cooled from the melting temperature of the molten salts to be analyzed and a temperature of 50 to 500° C. higher than the melting temperature to room temperature. Alternatively, the electrical conductivity may be measured by starting from the solid salt and increasing the temperature to the melting temperature or higher. However, considering the accuracy of data, when raising the temperature and preparing the graph of the change in electrical conductivity of the molten salts according to temperature change, it is preferable that the increase rate of the temperature is slow to 20° C./h or less. In this way, considering the time required for analysis and the accuracy of analysis, it is preferable to prepare the graph by cooling the temperature from the melting temperature of the molten salts or the temperature 50 to 500° C. higher than the melting temperature to the room temperature.

In Equation (1) of (iii) above, n is the number of data, and the range of n is not particularly limited. Considering the reliability of data, the range of n is preferably 10 or more, and may be an integer of 100 or less, for example, 50 or less, or 30 or less. Meanwhile, ΔT may refer to resolution at the interval of the measurement temperature, and this is also not particularly limited and may be adjusted as needed, but considering the reliability of data and the time required, ΔT is preferably 2 to 10° C.

Meanwhile, in the detecting of the outlier based on the distance from the linear regression equation of (iii) above, when the absolute value of the distance constant representing the distance from the linear regression equation is greater than or equal to the discrimination reference value in Table 1, it may be detected as the outlier. However, the discrimination reference value may also be adjusted as needed.

For example, in the detecting of the outlier based on the distance from the linear regression equation, at least one of the following Equations A to E may be applied. That is, the distance from the linear regression equation may be detected by selecting at least one of the above Equations.

$$Z ( A ) = {r}_{i} = {y}_{i} - {\hat{y}}_{i} \qquad ( Equation A )$$

$$Z ( B ) = {h}_{i} = \frac{1}{n} + \frac{{( {x}_{i} - \overline{x} )}^{2}}{SSX} \qquad ( Equation B )$$

$$Z ( C ) = {rs}_{i} = \frac{{r}_{i}}{\sqrt{{MSE}_{i} \times ( 1 - {h}_{i} )}} \qquad ( Equation C )$$

$$Z ( D ) = \frac{{{r}_{i}}^{2}}{( k + 1 ) MSE} [ \frac{{h}_{i}}{{( 1 - {h}_{i} )}^{2}} ] \qquad ( Equation D )$$

$$Z ( E ) = {rs}_{i} \sqrt{\frac{{h}_{i}}{( 1 - {h}_{i} )}} \qquad ( Equation E )$$

In more detail, the algorithm proceeds based on the discrimination reference value disclosed in Table 1 below.

TABLE 1

| Distance constant | |
|---|---|
| derivation formula | Discrimination reference value |
| Equation A | 2 |
| Equation B | The smaller value of 6/n and 0.99 |
| Equation C | 2 |
| Equation D | 1 |
| Equation E | When n is smaller than 30, it is 1, |
| | when n is greater than or equal to 30, |
| | it is 2/n^{0.5} |

For example, when applying both the Equations A to E, if the absolute value of the distance constant is less than the discrimination reference value in Table 1 when applying the selected Equation, algorithm proceeds in a manner of re-performing the linear regression analysis, adding n as n+1, re-performing the linear regression analysis, and adding 1 to n again, i.e. n+2. In this case, it is not necessary to satisfy all the Equations A to E, and independently confirm whether it is less than the discrimination reference value according to each Equation. When the absolute value of the distance constant according to Equations A to E is greater than or equal to the discrimination reference value, the determining of the point as the outlier, and determining the temperature of the point as the liquidus temperature T_{L} may be performed.

Meanwhile, the detecting of the outlier based on the distance from the linear regression equation in (iii) above ends when the liquidus temperature T_{L} becomes equal to the solidus temperature T_{S}.

For example, the present disclosure may include: increasing the temperature of the solid molten salts and preparing a graph of the change in electrical conductivity of the molten salts according to the temperature increase; determining solidus temperature T_{S} by performing the first-order differential or second-order differential on the graph of the change in electrical conductivity of the molten salts according to the temperature increase; melting the molten salts by raising the temperature to a temperature 50 to 500° C. higher than the melting temperature of the molten salts; preparing the graph of the change in electrical conductivity of the molten salts as the temperature decreases while cooling the temperature of the molten salts to room temperature; and determining the number n of data and resolution ΔT based on the graph of the change in electrical conductivity of the molten salts according to the temperature drop to derive Tₙ using Equation (1) and performing linear regression analysis on a linear section to detect an outlier based on a distance from the linear regression equation, the detecting of the outlier includes, applying one or more selected from Equations A to E, and based on the distance constant confirmed based on the Equation(s), re-performing the linear regression analysis and adding n as n+1, if an absolute value of a distance constant is less than a discrimination reference value, and determining as an outlier when the absolute value of the distance constant is greater than or equal to a discrimination reference value, and determining temperature at that point as the liquidus temperature T_{L}.

Hereinafter, the present disclosure will be described in more detail through specific examples. The following examples are merely illustrative to help in an understanding of the present disclosure, and the scope of the present disclosure is not limited thereto.

### EXAMPLE

### 1. Material and Equipment

To perform electrical conductivity measurement, a customized glass capillary cell (1.5 mm in inner diameter, 3 cm in capillary length) was used. In this case, a Pt line (1 mm in diameter) was used to make electrical contact between the capillary cell and a highly conductive liquid. Electrical conductivity values were obtained by measuring a step voltage in units of microseconds using a potentiometer.

Meanwhile, a cell constant is a coefficient used to convert a measured resistance (or the reciprocal of resistance) into conductivity, and the capillary cell is selected to have a cell constant in an appropriate range.

Generally, for highly conductive liquids, cells with values greater than or equal to 300 cm⁻¹ are recommended. The cell constant was measured in a constant temperature water bath at 291 K by putting a KCl standard solution of known conductivity into the capillary cell, which was determined using Equation below.

$$C = k \times R$$

Here, C represents the cell constant (cm⁻¹), k represents the electrical conductivity (S cm⁻¹) of the solution, R represents the resistance of the solution, and R value was determined from an slope of a current-voltage curve obtained from a method for measuring a step voltage in units of microseconds.

### 2. Method for Determining Phase Transition Temperature of Molten Salts

According to the present disclosure, in the molten salt mixture, by using the electrical conductivity measurement system described above in the material and equipment of 1. above, it is possible to measure an electrical conductivity value at regular intervals while lowering the temperature, and by applying a series of mathematical algorithms to the measured value, it is possible to objectively and accurately determine the phase transition temperature.

### (1) Electrical Conductivity Measurement

To measure the electrical conductivity of the molten salt at high temperature, the molten salt mixture was inserted into a quartz vessel and then inserted into a high-temperature furnace in a glove box (99.999% of argon, both moisture and oxygen <1 ppm). The temperature of the high-temperature furnace was controlled and monitored using a thermocouple, and the thermocouple was placed as close to the end of the capillary cell as possible to measure the accurate temperature. To determine the phase transition of the molten salts mixture, the electrical conductivity was measured at regular intervals while lowering the temperature in the range of 300 to 650° C.

### (2) Determination of Phase Transition Temperature Based on Mathematical Algorithm

### 1) Second-Order Differential Method

The measured electrical conductivity-temperature curve may be subjected to first and/or second-order differential, and a point where the first-order differential result is highest and the value at which an inflection point becomes 0 in the second-order differential result may be determined as the phase transition temperature. This method may distinguish transition points that are difficult to determine as intersection of a simple linear regression equation, and may determine more accurate temperature by appropriately adjusting a temperature interval corresponding to a resolution.

However, for example, in a molten salt system of a composition with two phase transition temperatures, which are solidus temperature T_{S} and liquidus temperature T_{L}, when the temperature interval between T_{S} and T_{L} is narrow, calculations based on differential may lead to inaccuracy in some cases. The phase transition temperature may be determined using a method for determining phase transition temperature based on a mathematical algorithm as shown below, or by additionally performing this method.

### 2) Analysis Algorithm Using Linear Regression and Statistical Data Analysis

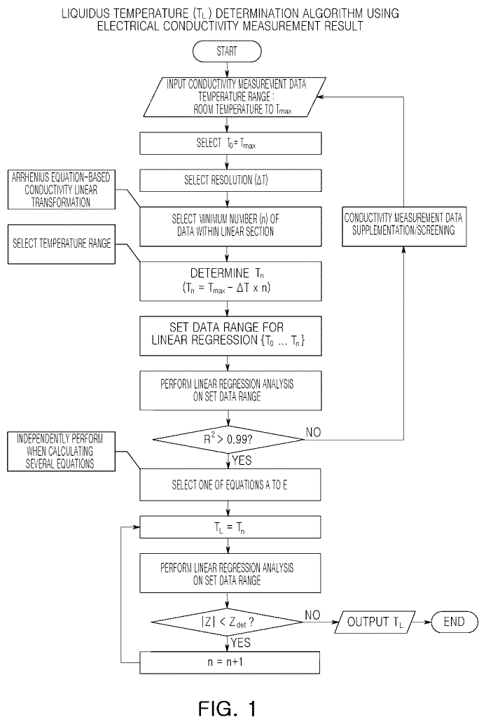

As shown in the algorithm flowchart of FIG. 1, the

phase transition temperature may be determined by a systematic method for determining a value according to various statistical evaluation criteria of Equations A, B, C, D, and E.

In this case, the definitions of each description in the above algorithm are as follows.
T₀=Tₘₐₓ: Highest temperature at which measurement of conductivity value begins.
Tₙ=Minimum temperature within linear section
Tₘₐₓ=Maximum temperature
T_{L}=Liquidus temperature
ΔT =Resolution
n=Minimum number of data
R²=Coefficient of determination
Z=Distance constant
   |Z|=Absolute value of distance constant
Z_{det}=Discrimination reference value

Furthermore, Equations A, B, C, D, and E are exemplary statistical equations that may evaluate how far the data value is from the linear regression equation, which is as follows:

$$Z ( A ) = {r}_{i} = {y}_{i} - {\hat{y}}_{i} \qquad ( Equation A )$$

$$Z ( B ) = {h}_{i} = \frac{1}{n} + \frac{{( {x}_{i} - \overline{x} )}^{2}}{SSX} \qquad ( Equation B )$$

$$Z ( C ) = {rs}_{i} = \frac{{r}_{i}}{\sqrt{{MSE}_{i} \times ( 1 - {h}_{i} )}} \qquad ( Equation C )$$

$$Z ( D ) = \frac{{{r}_{i}}^{2}}{( k + 1 ) MSE} [ \frac{{h}_{i}}{{( 1 - {h}_{i} )}^{2}} ] \qquad ( Equation D )$$

$$Z ( E ) = {rs}_{i} \sqrt{\frac{{h}_{i}}{( 1 - {h}_{i} )}} \qquad ( Equation E )$$

In this case, the definitions of the items described in each equation are as follows.
n: Number of data
k: Number of independent terms in regression model (e.g., for a linear model, y=ax+b, so two as a and b)
yᵢ: i-th y value
ŷᵢ: Predicted i-th y value
xᵢ: i-th x value
x̅: Average of x value

$$SSX = \sum {( {x}_{i} - \overline{x} )}^{2}$$

$$SSE = \sum {( {y}_{i} - {\hat{y}}_{i} )}^{2}$$

$$df = n - k - 1$$

$$MSE = \frac{SSE}{df}$$

$${MSE}_{i} = \frac{MSE - {{r}_{i}}^{2}}{( 1 - {h}_{i} ) \times df} \times \frac{df}{df - 1}$$

### 3. Experimental Example: Determination of Phase Transition Temperature

LiCl—KCl molten salts were measurement targets, which are chloride-based molten salts used for thermochemical reprocessing of spent nuclear fuel. Various physical properties of the corresponding molten salts have been investigated by several researchers. The melting temperature depending on the KCl (or LiCl) composition has been measured in several studies using a thermal analysis method, for example.

To demonstrate the validity of the electrical conductivity-based phase transition temperature determination method, the electrical conductivity-temperature curve was obtained from a LiCl—KCl-based molten salt mixture, and the solidus temperature (T_{S}: solidus temperature) and liquidus temperature (T_{L}: liquidus temperature) were determined, respectively.

As a result, all the measured temperature values were compared with previously reported reliable results.

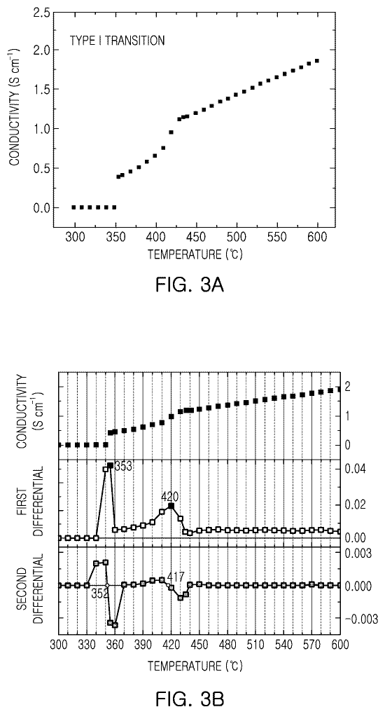

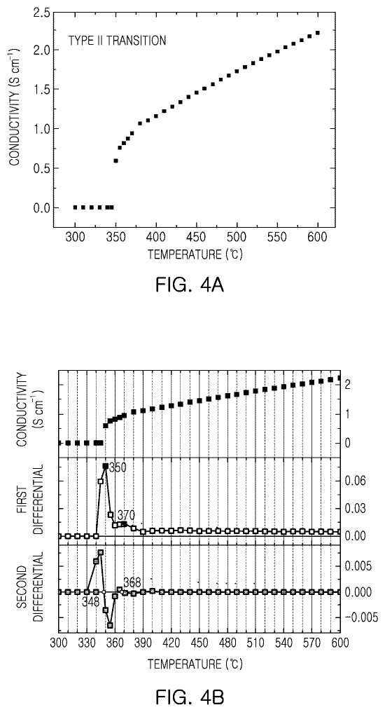

FIG. 3A illustrates the electrical conductivity-temperature curve measured in LiCl—KCl—NdCl₃ (30 wt %) molten salts and FIG. 3B illustrates the first differential and second differential result graphs for determining the phase transition temperature, and FIG. 4A illustrates the electrical conductivity-temperature curve measured in LiCl—KCl—NdCl₃ (15 wt %) molten salts and FIG. 4B the first differential and second differential result graphs for determining the phase transition temperature. In this case, wto is expressed as a percentage of a mass of NdCl₃ compared to the mass of the total solution, using the LiCl—KCl eutectic mixture as a solvent.

In Experimental Example 1 (Type I) of FIG. 3, when a gap between T_{S} and T_{L} was sufficiently wide, the accurate transition temperature could be determined based on the first and/or second-order differential of the corresponding curve. T_{S} measured in this way was confirmed to be 353° C. (first-order differential), 352° C. (second-order differential), and T_{L} was confirmed to be 420° C. (first-order differential) and 417° C. (second-order differential), respectively, which were confirmed to be very similar to the values presented in the literature (T_{S}: 355° C. and T_{L}: 424° C.).

Meanwhile, as in Experimental Example 2 (Type II) of FIG. 4, when the gap between T_{S} and T_{L} is narrower than 25° C., it may be difficult to clearly determine the inflection point corresponding to T_{L}. Therefore, additional T_{L,cal} values that meet the statistical evaluation criteria presented in the present disclosure were calculated as in Table 1 and compared in Table 2.

Table 2 shows the results obtained from statistical equations A to E that evaluate how much the data values deviate from the linear regression equation. In Table 2below, column 1 represents n, columns 2 and 3 represent T (absolute temperature, value obtained by adding 273 to Celsius temperature) and x value (1/T, reciprocal of absolute temperature), respectively, and column 4 represents y value (ln k). Column 5 represents the predicted ŷ value from the linear regression equation. A, B, C, D, and E represented in columns 6 to 10 show values calculated by substituting each of the above Equations.

TABLE 2

| | | | | | A | B | C | D | E |
|---|---|---|---|---|---|---|---|---|---|
| [symbol] | T/K | X(I/T) | Y(Ink) | Pred Y | Residual | Leverage | RStudent | Cook's D | DEFITS |
| 1 | 873 | 0.00115 | 0.79416 | 0.79742 | −0.00326 | 0.11386 | −0.05090 | 0.00017 | −0.01825 |
| 2 | 863 | 0.00116 | 0.77262 | [symbol] | −0.00221 | 0.10505 | −0.03428 | 0.00007 | −0.01174 |
| 3 | 853 | 0.00117 | 0.74998 | 0.73171 | −0.00173 | 0.09656 | −0.02670 | 0.00004 | −0.00873 |
| 4 | 843 | 0.00119 | 0.72810 | 0.72804 | 0.00007 | 0.08843 | 0.00102 | 0.00000 | 0.00032 |
| 5 | 833 | 0.00120 | 0.70624 | 0.70380 | 0.00243 | 0.08068 | 0.03729 | 0.00006 | 0.01105 |
| 6 | 823 | 0.00122 | 0.67974 | 0.67898 | 0.00076 | 0.07335 | 0.01166 | 0.00001 | 0.00328 |
| 7 | 813 | 0.00123 | 0.65621 | 0.65354 | 0.00267 | 0.06648 | 0.04063 | 0.00006 | 0.01084 |
| 8 | 803 | 0.00125 | 0.63145 | 0.62747 | 0.00398 | 0.06011 | 0.06033 | 0.00012 | 0.01326 |
| 9 | 793 | 0.00126 | 0.60365 | 0.60075 | 0.00290 | 0.05428 | 0.04386 | 0.00006 | 0.01051 |
| 10 | 783 | 0.00128 | 0.57528 | 0.57334 | 0.00195 | 0.04905 | 0.02933 | 0.00002 | 0.00666 |
| 11 | 773 | 0.00129 | 0.54517 | 0.54522 | −0.00005 | 0.04446 | 0.00071 | [symbol] | −0.00015 |
| 12 | 763 | 0.00131 | [symbol] | 0.51636 | −0.00289 | 0.04057 | −0.04333 | 0.00004 | [symbol] |
| 13 | 753 | 0.00133 | 0.48213 | 0.48674 | −0.00461 | 0.03745 | −0.06902 | 0.00010 | −0.01361 |
| 14 | 743 | 0.00135 | 0.44431 | 0.45632 | −0.01199 | 0.03515 | −0.17944 | 0.00061 | −0.03425 |
| 15 | 733 | 0.00136 | 0.40877 | 0.42567 | −0.01630 | 0.03376 | −0.24395 | 0.00108 | −0.04560 |
| 16 | 728 | 0.00137 | 0.39532 | 0.40913 | −0.01380 | 0.03342 | −0.20648 | 0.00076 | −0.03839 |
| 17 | 723 | 0.00138 | 0.37305 | 0.39296 | −0.01991 | 0.03334 | −0.29806 | 0.00158 | −0.05535 |
| 18 | 718 | 0.00139 | 0.35262 | 0.37657 | −0.02395 | 0.03352 | −0.35884 | 0.00230 | −0.06683 |
| 19 | 713 | 0.00140 | 0.33624 | 0.35994 | −0.02370 | 0.03398 | −0.35523 | 0.00229 | −0.06663 |
| 20 | 708 | 0.00141 | 0.31260 | 0.34309 | −0.03049 | 0.03473 | −0.45784 | 0.00388 | −0.08685 |
| 21 | 703 | 0.00142 | 0.28882 | 0.32599 | −0.03717 | 0.03578 | −0.55954 | 0.00396 | −0.10779 |
| 22 | 698 | 0.00143 | 0.26925 | 0.30365 | −0.03939 | 0.03715 | −0.59389 | 0.00697 | −0.11665 |
| 23 | 693 | 0.00144 | 0.24343 | 0.29106 | −0.04763 | 0.03884 | −0.72084 | 0.01068 | −0.14490 |
| 24 | [symbol] | 0.00146 | 0.19923 | [symbol] | −0.05587 | 0.04326 | −0.85064 | 0.01652 | −0.18088 |
| 25 | 673 | 0.00149 | 0.14710 | 0.21807 | −0.07097 | 0.04916 | −1.09311 | 0.03067 | −0.24855 |
| 26 | 663 | 0.00151 | 0.09939 | 0.17993 | −0.08055 | 0.05667 | −1.25382 | 0.04627 | −0.30731 |
| 27 | 653 | 0.00153 | 0.06065 | 0.14062 | −0.07997 | 0.06593 | −1.25090 | 0.05413 | −0.99234 |
| 28 | 643 | 0.00156 | −0.06298 | 0.10009 | −0.16307 | 0.07710 | −2.84403 | 0.26961 | −0.82203 |
| 29 | 638 | 0.00157 | −0.13720 | 0.07935 | −0.21654 | 0.08345 | −4.32537 | 0.52174 | −1.30516 |
| 30 | 633 | 0.00158 | −0.20582 | 0.05827 | −0.26410 | 0.09034 | | 0.85292 | −2.06278 |
| 31 | 623 | 0.00161 | −1.22781 | 0.01512 | −1.24292 | 0.10584 | | 22.90659 | |
| 32 | 613 | 0.00163 | −6.44702 | −0.02943 | −6.41758 | 0.12380 | | 743.88273 | |
| 33 | 603 | 0.00166 | −9.39146 | −0.07549 | −9.31597 | 0.14444 | | | |

[symbol]

indicates data missing or illegible when filed

For the electrical conductivity-temperature curve measured in (0.56LiCl-0.44KCl)—NdCl₃ (15 wt %) salt, the T_{L} values obtained from the analysis algorithm using the linear regression and statistical data analysis were summarized in Table 3 below.

TABLE 3

| | T_{L, cal} | % Difference |
|---|---|---|
| Value presented in literature | 382 | |
| [J. Mol. Liq. 382 (2023) 121869] | | |
| A | 350 | 8.4 |
| B | 330 | 13.6 |
| C | 380 | 0.5 |
| D | 360 | 5.8 |
| E | 370 | 3.1 |

As a result, as can be seen in Table 3, in the case of the electrical conductivity-temperature curve of FIG. 4, the % difference value calculated from the value reported in the literature showed a difference of about 10%, which was confirmed in the order C<E<D<A<B.

In addition, in order to confirm objectivity and suitability according to the evaluation method for Equations A to E, for the electrical conductivity-temperature curve with different result values using 0.70LiCl-0.30KCl salts with different compositions, the T_{L} values obtained from the analysis algorithm using the linear regression and statistical data analysis were summarized in Table 4 below.

TABLE 4

| | T_{L, cal} | % Difference |
|---|---|---|
| Value presented in literature | 452 | |
| [Russ. J. Inorg. Chema. 53 | | |
| (2008) 1509] | | |
| A | 360 | 20.4 |
| B | 350 | 22.6 |
| C | 450 | 0.4 |
| D | 445 | 1.5 |
| E | 450 | 0.4 |

As a result, as can be seen in Table 4 above, the % difference values compared to the literature values showed differences in the order C, E<D<A<B. In common, it can be seen that methods C and E showed small differences from the literature values, and methods A and B showed relatively large differences.

As such, it may be expected that the method of integrating values according to various statistical evaluation criteria based on the present disclosure may provide a level of objectivity, rationality, and sensitivity control to achieve a desired level of uncertainty.

In other words, the system for determining phase transition temperature using electrical conductivity measurement according to the present disclosure is very promising as a new methodology for measuring the phase transition temperature of various multi-component molten salts systems, and this technology has a much simpler and faster measurement system compared to the existing thermal analysis techniques. Meanwhile, this analysis algorithm enables consistent determination of transition temperature under any conditions and environments.

According to the method for determining phase transition temperature using electrical conductivity, by measuring electrical conductivity of a target and adopting a series of mathematical algorithms using the measured electrical conductivity to determine the phase transition temperature, it is possible to simply and quickly calculate accurate phase transition temperature values. Therefore, according to the present disclosure, it is expected that the phase transition temperature values experimentally determined in high-temperature molten salts, etc., may be used as reference data for phase equilibrium diagrams based on computational thermodynamics.

While exemplary embodiments have been illustrated and described above, it will be apparent to those skilled in the art that modifications and variations could be made without departing from the scope of the present disclosure as defined by the appended claims.

What is claimed is:

1. A method for measuring phase transition temperature using electrical conductivity, comprising:
preparing a graph of change in electrical conductivity of molten salts according to temperature; and
performing at least one mathematical analysis of (i) performing a first-order differential on the graph,
(ii) performing a second-order differential on the graph, and
(iii) determining the number (n) of data and resolution (ΔT) based on the graph to derive Tₙ by Equation (1) below and performing linear regression analysis on a linear section to detect an outlier based on a distance from the linear regression equation,
$${T}_{n} = {T}_{max} - Δ T \times n \qquad Equation ( 1 )$$
where n denotes the number of data, and ΔT denotes an interval of measurement temperature and means resolution.

2. The method of claim 1, wherein in case of (i), a point where a value is highest when processing the first-order differential, in case of (ii), an inflection point where the value becomes 0 when processing the second-order differential, and in case of (iii), temperature corresponding to the outlier are determined as the phase transition temperature.

3. The method of claim 1, wherein when a difference between liquidus temperature (T_{L}) and solidus temperature (T_{S}) is 25° C. or lower, the mathematical analysis of (iii) is performed.

4. The method of claim 1, wherein the temperature change refers to cooling the temperature from melting temperature of the molten salts to be analyzed or 50 to 500° C. higher than the melting temperature to room temperature or increasing the temperature from solid molten salts to the melting temperature or higher.

5. The method of claim 1, wherein the molten salts include at least one component selected from the group consisting of LiCl—KCl, NaCl—KCl, CsCl—KCl, LiCl—NaCl—CaCl₂—BaCl₂, NaCl—KCl—BaCl₂, CaF₂, NdCl₃, CeCl₃, and LaCl₃.

6. The method of claim 1, wherein the phase transition temperature is liquidus temperature (T_{L}).

7. The method of claim 1, wherein in Equation (1) of (iii) above, n is an integer from 10 to 100, and ΔT is 2 to 10° C.

8. The method of claim 1, further comprising re-performing the linear regression analysis and adding n as n+1 if an absolute value of a distance constant is less than a discrimination reference value, and
determining as an outlier if the absolute value of the distance constant below is greater than or equal to a discrimination reference value, and determining temperature at that point as the liquidus temperature (T_{L}),
when applying one or more of Equations A to E below.
$$Z ( A ) = {r}_{i} = {y}_{i} - {\hat{y}}_{i} \qquad ( Equation A )$$
$$Z ( B ) = {h}_{i} = \frac{1}{n} + \frac{{( {x}_{i} - \overline{x} )}^{2}}{SSX} \qquad ( Equation B )$$
$$Z ( C ) = {rs}_{i} = \frac{{r}_{i}}{\sqrt{{MSE}_{i} \times ( 1 - {h}_{i} )}} \qquad ( Equation C )$$
$$Z ( D ) = \frac{{{r}_{i}}^{2}}{( k + 1 ) MSE} [ \frac{{h}_{i}}{{( 1 - {h}_{i} )}^{2}} ] \qquad ( Equation D )$$
$$Z ( E ) = {rs}_{i} \sqrt{\frac{{h}_{i}}{( 1 - {h}_{i} )}} \qquad ( Equation E )$$
(In this case, definitions of items described in each equation are as follows:
n: Number of data
k: Number of independent terms in regression model
yᵢ: i-th y value
ŷᵢ: Predicted i-th y value
xᵢ: i-th x value
x̅: Average of x value
$$SSX = \sum {( {x}_{i} - \overline{x} )}^{2}$$
$$SSE = \sum {( {y}_{i} - {\hat{y}}_{i} )}^{2}$$
$$df = n - k - 1$$
$$MSE = \frac{SSE}{df}$$
$${MSE}_{i} = \frac{MSE - {{r}_{i}}^{2}}{( 1 - {h}_{i} ) \times df} \times \frac{df}{df - 1} )$$

9. The method of claim 8, wherein in the detecting of the outlier based on the distance from the linear regression equation in (iii) above, when the absolute value of the distance constant representing the distance from the linear regression equation is greater than or equal to each of the following discrimination reference values in each distance constant derivation equations A to E, it is detected as the outlier.
Equation A: 2
Equation B: Smaller value of 6/n and 0.99
Equation C: 2
Equation D: 1
Equation E: When n is less than 30, it is 1, and when n is greater than or equal to 30, it is 2/n^{0.5}

10. The method of claim 8, wherein the detecting of the outlier based on the distance from the linear regression equation in (iii) above ends when the liquidus temperature (T_{L}) becomes equal to the solidus temperature (T_{S}).

11. The method of claim 1, further comprising:
increasing the temperature of the solid molten salts and preparing a graph of the change in electrical conductivity of the molten salts according to the temperature increase;
determining solidus temperature (T_{S}) by performing the first-order differential or the second-order differential on the graph of the change in electrical conductivity of the molten salts according to the temperature increase;
melting the molten salts by increasing the temperature to a temperature 50 to 500° C. higher than the melting temperature of the molten salts;
preparing the graph of the change in electrical conductivity of the molten salts as the temperature decreases while cooling the temperature to room temperature; and
determining the number (n) of data and resolution (ΔT) based on the graph of the change in electrical conductivity of the molten salts according to the temperature drop to derive Tₙ using Equation (1) above and performing linear regression analysis on a linear section to detect an outlier based on a distance from the linear regression equation,
wherein the detecting of the outlier includes, re-performing the linear regression analysis and adding n as n+1, if an absolute value of a distance constant is less than a discrimination reference value, and
determining as an outlier if the absolute value of the distance constant below is greater than or equal to a discrimination reference value, and determining temperature at that point as the liquidus temperature (T_{L}),
when applying one or more of Equations A to E below.
$$Z ( A ) = {r}_{i} = {y}_{i} - {\hat{y}}_{i} \qquad ( Equation A )$$
$$Z ( B ) = {h}_{i} = \frac{1}{n} + \frac{{( {x}_{i} - \overline{x} )}^{2}}{SSX} \qquad ( Equation B )$$
$$Z ( C ) = {rs}_{i} = \frac{{r}_{i}}{\sqrt{{MSE}_{i} \times ( 1 - {h}_{i} )}} \qquad ( Equation C )$$
$$Z ( D ) = \frac{{{r}_{i}}^{2}}{( k + 1 ) MSE} [ \frac{{h}_{i}}{{( 1 - {h}_{i} )}^{2}} ] \qquad ( Equation D )$$
$$Z ( E ) = {rs}_{i} \sqrt{\frac{{h}_{i}}{( 1 - {h}_{i} )}} \qquad ( Equation E )$$
(In this case, definitions of items described in each equation are as follows:
n: Number of data
k: Number of independent terms in regression model
yᵢ: i-th y value
ŷᵢ: Predicted i-th y value
xᵢ: i-th x value
x̅: Average of x value
$$SSX = \sum {( {x}_{i} - \overline{x} )}^{2}$$
$$SSE = \sum {( {y}_{i} - {\hat{y}}_{i} )}^{2}$$
$$df = n - k - 1$$
$$MSE = \frac{SSE}{df}$$
$${MSE}_{i} = \frac{MSE - {{r}_{i}}^{2}}{( 1 - {h}_{i} ) \times df} \times \frac{df}{df - 1} ,$$
wherein each discrimination reference value in each distance constant derivation Equations A to E is as follows:
Equation A: 2
Equation B: Smaller value of 6/n and 0.99
Equation C: 2
Equation D: 1
Equation E: When n is less than 30, it is 1, and when n is greater than or equal to 30, it is 2/n^{0.5})
